(19) United States
(12) Patent Application Publication
(10) Pub. No.: US 2007/0211873 A1
(43) Pub. Date: Sep. 13, 2007

(54) Method and system for outputting caller information

(76) Inventor: Jun Wang, Shenzhen (CN)

Correspondence Address: LADAS & PARRY LLP, 224 SOUTH MICHIGAN AVENUE, SUITE 1600, CHICAGO, IL, 60604, US

(21) Appl. No.: 11/653,545

(22) Filed: Jan. 16, 2007

Related U.S. Application Data
(63) Continuation of application No. PCT/CN05/02130, filed on Dec. 8, 2005.

(30) Foreign Application Priority Data
Dec. 21, 2004 (CN) 2004 1010 4416.4

(51) Int. Cl. H04M 15/06; H04M 1/56

(52) U.S. Cl. 379/142.01

(57) ABSTRACT

A method for outputting caller information which is saved in a caller information server, including: upon receiving a call request carrying a calling number from a switching system, the called terminal sends a request for caller information carrying the calling number to the caller information server according to the calling number; the caller information server queries the caller information according to the calling number, and returning the caller information corresponding to the calling number to the called terminal; the called terminal outputs the caller information. A system and a terminal are provided by this invention as well. Implementation of the present invention helps to make full use of the capability of a terminal, simplify the processing in the switching system, lower the complexity of the processing in the switching system, and reduce the consumption of system resources of the switching system.

### FIELD OF THE INVENTION

The present invention is related to a method and a system for outputting caller information.

### BACKGROUND OF THE INVENTION

At present, it is possible to recognize the calling identity of a phone call in a mobile or fixed communication system. Calling Identity Delivery (CID) is to transfer by a switch such calling information as the calling number, the date and time of the call to the called terminal, and to output such information on the display of the called terminal and save the information. In this way, the user of the called terminal is able to learn the calling number before picking up the phone, or look up the received calling numbers upon coming back from outside. CID is typically implemented by cooperation of a switch with the function of calling identity recognition and a terminal with the function of calling identity display, and such information as the calling number and the calling time may be outputted on the called terminal.

The above-mentioned CID service only delivers relatively simple information like the calling number and the calling time, whereas a subscriber at present, either an individual or an enterprise, may wish to transmit or receive more diversified individualized information besides the calling number to identify the caller, such as name, individual profile, title of an enterprise, photo, ring tone, video, etc, or to have relatively sophisticated functions like outputting, according to the called terminal, the appropriate caller information configured by the caller.

In fact, it is possible for a mobile communication terminal to configure the name corresponding to a calling number in the phone directory of the called terminal such that the saved name of the calling number could be outputted on the called terminal when a caller with that calling number makes a call to the called terminal. The calling information outputted in this way, however, is limited to the information saved in the called terminal and a mobile terminal may save limited information of phone numbers. When there is an incoming call of which the calling number could not be identified, no calling information other than the calling number and the calling time could be outputted.

At present, a service based on intelligent network (IN) referred to as Calling Name Presentation (CNAP) is provided for mobile stations (MS). A caller may subscribe to this service such that the username of the caller could be outputted on the called terminal when the caller makes a call.

Refer to FIG. 1, which illustrates a network for implementing an IN-based CNAP service in the prior art. A caller may subscribe to a service at the network side (SCP) and have caller name information stored. In this way, when the caller (calling MS) makes a call, the SCP will transfer the caller name information to a switch (MSC), and the switch will forward the information to a called terminal (called MS). Refer to FIG. 2 for the calling process, which is the process for implementing the CNAP service in the prior art. The process includes the steps of:

Step 201: A calling mobile station (MS) sends to a calling mobile switching center (MSC) a call request for a called MS.

Step 202: the calling MSC acquires CAMEL Subscription Information (CSI) from a VLR (Visited Location Register) based on the call request, and triggers a CNAP service at the SCP according to the acquired CSI.

Step 203: The SCP instantly issues a connect operation to the calling MSC while modifying the calling number in the connect operation, i.e. adding a special CNAP prefix number to the calling number.

Step 204: The calling MSC, according to the connect operation, sends to a called MSC the call request carrying the calling number along with the special CNAP prefix number.

Step 205: The called MSC triggers a CNAP service at the calling SCP according to the special CNAP prefix number and the calling number segment in the call request.

Step 206: The calling SCP extracts the CNAP prefix number from the calling number and obtains the real calling number, then queries in the local database the caller name information to be outputted on the called terminal according to the calling and called numbers, and issues to the called MSC a connect operation, the extended interface of which carries the caller name information.

Step 207: The called MSC sends to the called terminal a call request and Facility operation, and includes the caller name information in the Facility operation.

Then the called MS outputs the caller name information received via the Facility operation.

To sum up, the above implementing approach is achieved by the switching system triggering an intelligent service when a calling terminal makes a call to the called terminal. The server that saves the caller information may be referred to as caller information server, and the SCP in the above approach is a caller information server. Refer to FIG. 3, which is a schematic diagram illustrating the logical relationship between a caller information server, a switching system, and calling and called terminals in the prior art.

As shown in FIG. 3, in the prior art, when a calling terminal 301 makes a call to a called terminal 303 via a switching system 302, the switching system 302 notifies a caller information server 304 to send caller information to the called terminal 303 via the switching system 302; or the switching system 302 acquires caller information from the caller information server 304 and sends the caller information to the called terminal 303. It may be seen that this approach requires appropriate processing by the switching system 302, which, however, primarily serves to switch voice or data and establish the session channel between the calling and called terminals.

### SUMMARY OF THE INVENTION

A method for outputting caller information, including:

saving the caller information in a caller information server;

upon receiving a call request carrying a calling number sent from a switching system, sending, by a called terminal, a request for caller information carrying the calling number to the caller information server according to the calling number;

querying, by the caller information server, the caller information according to the calling number;

returning, by the caller information server, the caller information corresponding to the calling number to the called terminal;

outputting, by the called terminal, the caller information.

A system for outputting caller information, including:

a switching system for sending a call request carrying a calling number;

a called terminal for sending, upon receiving the call request carrying the calling number from the switching system, a request for caller information carrying the calling number according to the calling number, and displaying the caller information;

a caller information server for saving the caller information, and querying the caller information according to the calling number carried in the request for caller information received from the called terminal, and returning the caller information corresponding to the calling number to the called terminal.

A terminal including means for sending a request for caller information to a caller information server upon receiving a call request, and outputting the caller information upon receiving the caller information from the caller information server.

### BRIEF DESCRIPTION OF THE DRAWINGS

FIG. 1 illustrates a network for implementing a service of Calling Name Presentation (CNAP) based on an intelligent network in the prior art.

FIG. 2 is a call flowchart for implementing a CNAP service in the prior art.

FIG. 3 is a schematic diagram illustrating the logical relationship between a caller information server, a switching system, and calling and called terminals in the prior art.

FIG. 4 is a schematic diagram illustrating the logical relationship between a caller information server, a switching system, and calling and called terminals in accordance with an embodiment of the present invention.

FIG. 5 is a call flowchart in accordance with preferred embodiment 1 of the present invention.

FIG. 6 is a call flowchart in accordance with preferred embodiment 2 of the present invention.

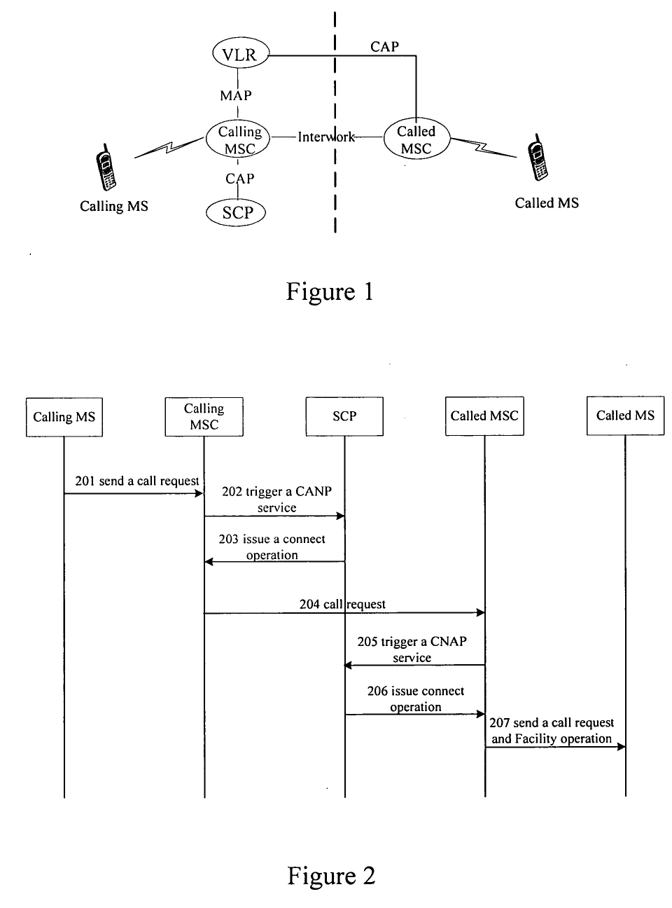

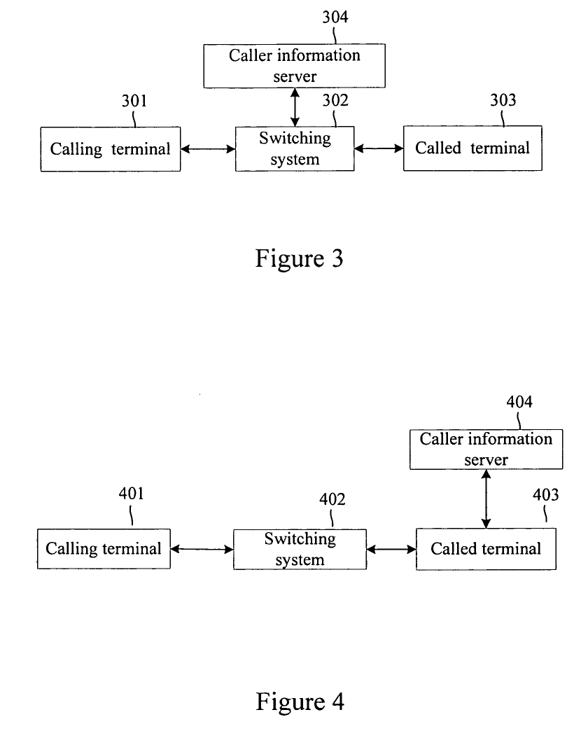

### DETAILED DESCRIPTION OF THE INVENTION

The present invention is hereinafter further described in detail with reference to the accompanying drawings as well as embodiments so as to make the technical solution and merits thereof more apparent.

In accordance with the method for outputting caller information, the caller information is saved in a caller information server, and a called terminal, upon receiving a call request sent from a switching system, communicates directly with the caller information server and acquires the caller information which is outputted on the called terminal.

Refer to FIG. 4, which is a schematic diagram illustrating the logical relationship among a caller information server, a switching system, and calling and called terminals. Caller information has been saved in a caller information server 404.

A calling terminal 401 initiates a call request carrying a calling number to a called terminal 403 via a switching system 402. The called terminal 403, after receiving the call request, sends a request for caller information carrying the calling number to the caller information server 404. The caller information server 404 queries saved caller information based on the calling number carried in the call request sent from the called terminal 403, and returns caller information found corresponding to the calling number to the called terminal 403 The called terminal 403 outputs the received caller information.

The caller information server according to an embodiment of the present invention may be a Service Control Point (SCP), a USSD server, a Personal Information Management (PIM) server, or other special servers. The switching system may be a mobile communication switching system or a fixed communication switching system, and the calling and called terminals may be mobile communication terminals or fixed communication terminals. According to the existing communication specifications, such as those of GPRS, 3G, and NGN, a called terminal, while maintaining a normal voice channel with the switching system, may establish additional data links, e.g. a Class A cellular phone terminal of GPRS. Therefore, a called terminal may establish communication connection with a caller information server via GPRS, 3G, 4G, NGN, or Internet, and the communication protocol or mode adopted may be such a data communication protocol as TCP/IP, SIP, HTTP, or WAP, or such a mode as SMS or USSD.

Two preferred embodiments are hereinafter given to further describe the method of this invention.

### PREFERRED EMBODIMENT 1

In this embodiment, the caller information server may be an SCP or PIM server or a special caller information server. As SCP has to deal with many other communication services simultaneously, a PIM server or a special caller information server is preferred. The switching system in this embodiment is a mobile communication switching system, which includes such network elements as mobile switching center (MSC) and visited location register (VLR).

In this embodiment, the calling user saves the calling number and correspondingly configured user information in the caller information server via the Internet, WAP or SMS.

The caller information configured by a calling user may be information in the form of text, image, audio, multimedia, etc. Further, the calling user has configured different user information in connection with different called numbers or/and different time for the calling number. The records saved in the caller information server may be shown as Table 1:

TABLE 1

| Calling Number | Called Number | Caller information |
|---|---|---|
| 13000000001 | 13000000002 (home) | Personal photo |
| 13000000001 | 0755-28974157(colleague) | General manager of XX |
| | | Company: LI Qiang |
| 13000000001 | (default) | LI Qiang |
| 13000000001 | Friends (Group ID for | A Qiang |
| | multiple phone numbers) | |
| 0755-26661061 | IMS user (Operator A) | Good morning, this is |
| | | Customer service of XX |
| | | Company |

If caller information corresponding to different time is configured in the caller information server, it is possible to send appropriate caller information to the called terminal at different time. In such a case, the records saved in the caller information server may be shown as Table 2:

TABLE 2

| Calling Number | Time | Caller information |
|---|---|---|
| 13000000001 | 8:00-12:00 | Good morning, this is LI Qiang |
| 13000000001 | 21:00-24:00 | Good evening, this is LI Qiang. Sorry to |
| | | disturb you at the non-working time |

In addition, in this embodiment, the called terminal has saved as well such address information as the IP address, URL, corresponding phone number, or SMS number of the caller information server.

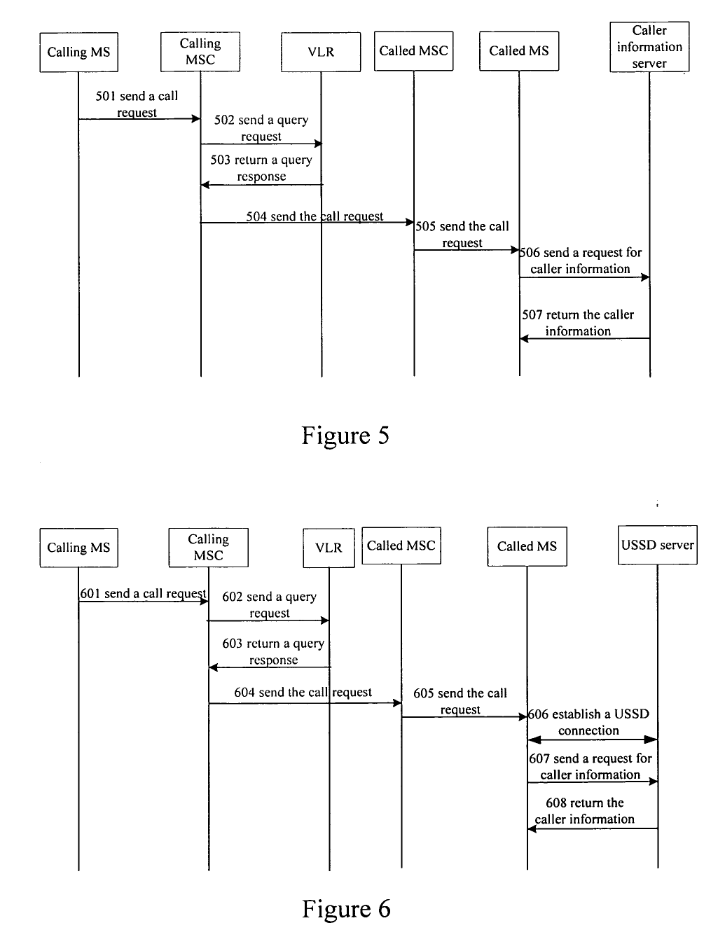

Refer to FIG. 5, which is a call flowchart of preferred embodiment 1 of the method. The calling terminal is a calling MS, and the called terminal is a called MS. The process includes the steps of:

Step 501: The calling MS sends to the calling MSC a call request for the called MS.

Step 502: The calling MSC sends a query request to the VLR according to the call request.

Step 503: The VLR returns to the calling MSC a query response, which carries CSI of the caller.

Step 504: The calling MSC sends the call request to the called MSC.

Step 505: The called MSC sends the call request to the called MS.

Step 506: The called MS sends to the caller information server a request for caller information, which carries the calling number and the called number.

Step 507: The caller information server finds the caller information of this calling user according to the calling number, finds the caller information configured for the called number according to the called number or/and the current time, and returns the caller information to the called terminal. The caller information server may send the caller information to the called terminal via a flash message, short message, WAP, HTTP, SIP or TCP/IP.

If the caller information server, e.g. SCP, sends the information to the called terminal i.e. the called MS via a flash message, the process may include the following 3 steps:

Step 1: SCP, according to the MS number of the called MS, sends to the HLR of the called MS a message requesting the routing information.

Step 2: HLR acknowledges the request from SCP, and returns the routing information to SCP.

Step 3: SCP sends a short message carrying the caller information to the called MS via the called MSC according to the returned routing information.

A flash message refers to a short message that may be outputted directly on the screen of the MS of a receiver and will not be automatically saved after being read. Refer to GSM 03.38 for the short message protocol. There are various methods for SCP to send a short message directly to the called MS, for example, the method in the embodiment of the invention patent application titled as “the implementing method for short message transmission and short message intelligent service” with the application number of CN 200310113468.3, or other implementing methods. No further description will be given here.

In this way, when the called MS has been switched off or is in a non-service area, the short message operation will be discarded by the network (no saving or forwarding) so as to avoid additional load on the network.

In fact, a caller information server like SCP may send as well the caller information by a short message to the short message center (SMC), and the SMC will send the short message carrying the caller information to the called terminal, i.e. the called MS via the called MSC. The process includes the following five steps:

Step 1: SCP encapsulates the caller information and the MS number of the called MS into a short message, and sends the message to SMC.

Step 2: SMC forwards the short message to the Short Message Center-Gateway Mobile Switching Center (SMC-GMSC).

Step 3: SMC-GMSC, according to the MS number of the called MS carried in the short message, sends to the HLR of the called MS a message requesting the routing information.

Step 4: HLR acknowledges the request from SMC-GMSC, and returns the routing information to SMC-GMSC.

Step 5: SMC-GMSC, according to the routing information, sends a short message carrying the user information to the called MS via the called MSC.

The above method in which the caller server sends a short message directly or via SMC to the called terminal is suitable to a called terminal which is unable to keep online while being unable to handle voice and data simultaneously, for it is possible for the called terminal to transmit/receive a short message using the signaling channel while receiving a call. In such a communication network as GPRS, 3G, and NGN, as it is possible for a communication terminal to keep online, a called terminal may communicate with the caller information server via such data communication protocol as WAP, HTTP, SIP, or TCP/IP while receiving a call, to acquire the caller information.

In this way, the called MS may output the received caller information to the user, may save the caller information together with the corresponding calling number, and may record the time of saving the caller information.

In this embodiment, the calling MSC or the called MSC may query the time of updating the caller information in the caller information server before sending the call request to the called terminal, and send the call request along with the time of updating the caller information to the called terminal.

The called terminal, after receiving the call request, may check according to the calling number in the call request whether the caller information of that user has been saved. If the caller information has not been saved, send a request for caller information to the caller information server; if the caller information has been saved, compare the time of updating the caller information with the last time of saving the caller information; if the time of updating the caller information is later than the last time of saving the caller information, send a request for caller information to the caller information server, otherwise, send no request for caller information to the caller information server.

In this embodiment, as the called terminal has recorded the time of saving the caller information, the called terminal may, when sending a request for caller information next time in connection with the same calling number, send the last time of saving the caller information along with the request for caller information to the caller information server.

After receiving the request for caller information, the caller information server compares the time of saving the caller information carried in the caller information server with the time of updating the caller information corresponding to the calling number saved in the server itself; if the time of updating the caller information is later than the time of saving the caller information carried in the request for caller information, sends the caller information to the called terminal, otherwise notifies the user terminal that the caller information has not been updated.

After receiving the above notification, the called terminal outputs the saved caller information corresponding to the calling number.

In practical applications, the caller information server may send the time of updating the caller information together with the caller information to the called terminal. The called terminal may save this time of updating as the time of saving the caller information by the called terminal. In this way, it is ensured that the time of updating or the time of saving caller information of one calling number which is saved by a plurality of called terminals and caller information servers remains consistent.

In addition, in this embodiment, if the caller information carries audio information, the called terminal may play the audio information as the ringing tone when receiving the caller information. In this way, an individualized ringing of caller is implemented, by which the caller could be recognized.

### PREFERRED EMBODIMENT 2

In this embodiment, the caller information server is a USSD server, the switching system is a mobile communication switching system, which includes such network elements as mobile switching center (MSC) and visited location register (VLR).

In this embodiment, the calling user saves the calling number and correspondingly configured user information in the caller information server via Internet or SMS, and the saving manner is the same as that in the preferred embodiment 1, which will not be further described here. Likewise, in this embodiment, the called terminal has saved as well such address information as IP address, URL, corresponding phone number, or SMS number of the caller information server.

Refer to FIG. 6, which is a call flowchart of the preferred embodiment 2. The calling terminal is a calling MS, and the called terminal is a called MS. The process includes the steps of:

Step 601: The calling MS sends to the calling MSC a call request for the called MS.

Step 602: The calling MSC sends a query request to the VLR according to the call request.

Step 603: The VLR returns to the calling MSC a query response, which carries CSI of the caller.

Step 604: The calling MSC sends the call request to the called MSC.

Step 605: The called MSC sends the call request to the called MS.

Step 606: The called MS establishes a connection with the USSD server.

Step 607: The called MS sends to the USSD server a request for caller information, which carries the calling number and the called number.

Step 608: The USSD server finds the caller information of this calling user according to the calling number, finds the caller information configured for the called number according to the called number or/and the current time, and returns the caller information to the called terminal.

The processing of the caller information by the called terminal after it receives the information is the same as that in the preferred embodiment 1, which will not be further described here. In the preferred embodiment 1, SCP implements the function of SMC by directly sending a short message to the called terminal. In this embodiment, SCP may also be used as the USSD server and may communicate with the called terminal in the USSD mode. Further, if caller information is not saved directly in the USSD server, another USSD application server may be configured for storing caller information, for example, a PIM server may be used as the USSD application server. After the called MS has established a connection with the USSD server and sent a request for caller information, the USSD may communicate with the USSD application server using the TCP/IP protocol, acquire the caller information and return the information to the called MS.

In addition, in the above two embodiments, it is possible to implement information synchronization between the called terminal and the caller information server. Specifically, there are two methods as follows:

First: The caller information server, when saving the caller information of a calling user, sends a request for synchronizing the caller information carrying the caller information to the called terminal designated by the calling user; or after saving the caller information of a calling user, sends the request for synchronizing the caller information carrying the caller information periodically to the called terminal designated by the calling user. After receiving the request for synchronizing the caller information, the called terminal saves or updates the caller information of the calling user.

Second: The called terminal sends the request for synchronizing the caller information periodically to the caller information server, and the request for synchronizing the caller information carries the calling number and the last time of saving the caller information corresponding to the calling number.

After receiving the request for synchronizing the caller information, the caller information server determines whether the last time of saving the caller information by the called terminal is earlier than the time of updating by the calling user the user information in the information server, if the last time of saving the caller information is earlier than the time of updating the caller information, sends updated user information to the called terminal to update the caller information in the called terminal; otherwise, terminates the synchronizing process.

After such a synchronization, when a calling user makes a call to the called terminal next time, the called terminal will send the saving time of synchronizing the caller information to the caller information server when the called terminal sends a request for caller information, and the caller information server will send no caller information after comparing the time, which saves the time transferring the caller information and makes it more possible for the called terminal to output the caller information in time.

In practical applications, a called terminal may determine whether to send a request for caller information to the caller information server in three manners as follows:

First: Save in the switching system a service flag indicating whether a user has subscribed to a caller information service; and the switching system, when sending a call request to a called terminal, sends the service flag corresponding to the calling user to the called terminal.

The called terminal determines according to the service flag whether the calling user has subscribed to the caller information service, if the calling user has subscribed to the caller information service, sends to the caller information server a request for caller information, otherwise, sends no request for caller information to the caller information server.

Second: configure a service flag indicating whether a calling user has subscribed to a caller information service and a segment of calling number for subscribing to the caller information service; and the switching system, before sending a call request to a called terminal, determines whether the calling number is in the above-mentioned segment of calling number, if the calling number is in the segment, sets the service flag as valid, and sends the service flag along with the call request to the called terminal.

The called terminal determines according to the service flag whether the calling user has subscribed to the caller information service, if the calling user has subscribed to the caller information service, sends to the caller information server a request for caller information, otherwise, sends no request for caller information to the caller information server.

Third: Configure a service flag indicating whether a calling user has subscribed to a caller information service and a prefix number for subscribing to the caller information service; and the switching system, before sending a call request to a called terminal, determines whether the calling number includes the above-mentioned prefix number, if the calling number includes the prefix number, sets the service flag as valid, and sends the service flag along with the call request to the called terminal.

The called terminal determines according to the service flag whether the calling user has subscribed to the caller information service, if the calling user has subscribed to the caller information service, sends to the caller information server a request for caller information, otherwise, sends no request for caller information to the caller information server.

It may be seen from the above embodiments that, in accordance with the method, system and terminal for outputting caller information, caller information is saved in a caller information server, and a called terminal, after receiving a call request sent from the switching system, communicates directly with the caller information server and acquires the caller information. In this process, the switching system is used only for transparent transmission without corresponding processing. As a result, the embodiments of the present invention make full use of the capability of the terminal, simplify the processing in the switching system, reduce the complexity of the processing in the switching system, and decrease the consumption of system resources of the switching system.

It will be apparent to those skilled in the art that various modifications and variations may be made in the present invention without departing from the spirit and scope thereof. Thus, it is intended that the present invention covers the modifications and variations of this invention that come within the scope of the appended claims and their equivalents.

What is claimed is:

1. A method for outputting caller information, comprising:
saving the caller information in a caller information server;
upon receiving a call request carrying a calling number sent from a switching system, sending, by a called terminal, a request for caller information carrying the calling number to the caller information server;
querying, by the caller information server, the caller information according to the calling number;
returning, by the caller information server, the caller information corresponding to the calling number to the called terminal;
outputting, by the called terminal, the caller information.

2. The method of claim 1, wherein the process of sending the request for caller information to the caller information server comprises:
sending, by the called terminal, the request for caller information to the caller information server according to the address information of the caller information server saved in the called terminal.

3. The method of claim 2, wherein the address information of the caller information server comprises one of: IP address of the caller information server, Uniformed Resource Locator (URL) of the caller information server, corresponding phone number of the caller information server and Short Message Service (SMS) number of the caller information server.

4. The method of claim 2, wherein the called terminal is connected with the caller information server via one of GPRS, 3G, 4G, NGN and Internet communications.

5. The method of claim 4, wherein the caller information server sends the caller information to the called terminal via one of a flash message, short message, WAP, HTTP, SIP and TCP/IP.

6. The method of claim 1, wherein the process of saving the caller information in a caller information server comprises:
saving, by a calling user, the caller information in the caller information server via one of Internet, WAP and SMS.

7. The method of claim 1, wherein the caller information comprises the calling number and calling user information configured correspondingly by a calling user.

8. The method of claim 7, wherein the process of saving the caller information further comprises:
configuring different calling user information corresponding to the calling number for different called numbers or/and different time;
the request for caller information further comprises a called number;
the process of querying further comprises:
querying, by the caller information server, the corresponding calling user information according to the called number.

9. The method of claim 8, wherein the calling user information comprises at least one kind of text, image, audio and multimedia information.

10. The method of claim 7, wherein the calling user information comprises at least one kind of text, image, audio or multimedia information.

11. The method of claim 10, wherein when the caller information received by the called terminal comprises audio information, the process of outputting by the called terminal the caller information comprises:
playing, by the called terminal, the audio information as ringing tone.

12. The method of claim 1, further comprising:
outputting, by the called terminal, the calling number on a display screen and prompting that the caller information is being acquired when the called terminal sends the request for caller information to the caller information server.

13. The method of claim 1, further comprising:
terminating information interaction between the called terminal and the caller information server if the called terminal answering.

14. The method of claim 1, further comprising:
saving, by the called terminal, the caller information together with the calling number correspondingly upon receiving the caller information.

15. The method of claim 14, further comprising:
before sending the request for caller information to the caller information server, searching, by the called terminal, self-stored caller information according to the calling number, if the caller information corresponding to the calling number has been found, not sending the request for caller information to the caller information server.

16. The method of claim 14, further comprising:
recording, by the called terminal, time of saving the caller information;
querying, by the switching system, before sending the call request to a called terminal, time of updating the caller information in the caller information server, sending the call request along with the time of updating the caller information to the called terminal;
upon receiving the call request, checking, by the called terminal, whether the caller information has been saved according to the calling number in the call request, if the caller information has not been found, sending the request for caller information to the caller information server; if the caller information has been found, comparing the time of updating the caller information with last time of saving the caller information, if the time of updating the caller information is later than the last time of saving the caller information, sending the request for caller information to the caller information server, otherwise, not sending the request for caller information to the caller information server.

17. The method of claim 16, wherein the caller information further comprises the time of updating the caller information saved in the caller information server;
the process of recording by the called terminal time of saving the caller information comprises:
recording, by the called terminal, the time of updating the caller information saved in the caller information server carried in the caller information.

18. The method of claim 14, further comprising:
recording, by the called terminal, time of saving the caller information;
when sending the request for caller information in connection with the calling number next time, sending, by the called terminal, last time of saving the caller information along with the request for caller information to the caller information server;
upon receiving the request for caller information, comparing, by the caller information server, the last time of saving the caller information carried in the request for caller information with the time of updating the caller information corresponding to the calling number saved in the caller information server itself, if the time of updating the caller information is later than the last time of saving the caller information, sending the caller information to the called terminal; otherwise notifying the called terminal that the caller information has not been updated, and outputting, by the called terminal, after receiving the notification, the caller information corresponding to the calling number.

19. The method of claim 18 wherein the caller information further comprises the time of updating the caller information saved in the caller information server;
the process of recording by the called terminal time of saving the caller information comprises:
recording, by the called terminal, the time of updating the caller information saved in the caller information server carried in the received caller information.

20. The method of claim 1, further comprising:
while saving the caller information, sending, by the caller information server, a request for synchronizing the caller information carrying the caller information to the called terminal;
saving, by the called terminal, the caller information of the calling user upon receiving the request for synchronizing the caller information.

21. The method of claim 1, further comprising:
while saving the caller information, sending, by the caller information server, periodically, a request for synchronizing the caller information carrying the caller information to the called terminal;
updating, by the called terminal, the caller information upon receiving the request for synchronizing the caller information.

22. The method of claim 1, further comprising:
sending, by the called terminal, periodically, a request for synchronizing the caller information to the caller information server, wherein the request for synchronizing the caller information carries the calling number and the last time of saving the caller information corresponding to the calling number;
upon receiving the request for synchronizing the caller information, determining, by the caller information server, whether the last time of saving the caller information by the called terminal is earlier than the time of updating the user information by the calling user in the information server, if the last time is earlier than the time of updating, sending updated user information to the called terminal to update the caller information in the called terminal; otherwise, terminating synchronizing process.

23. The method of claim 1, further comprising:
saving, in the switching system, a service flag indicating whether a calling user has subscribed to a caller information service;
when sending the call request to the called terminal, sending, by the switching system, the service flag corresponding to the calling user to the called terminal;
determining, by the called terminal, according to the service flag, whether the calling user has subscribed to the caller information service, if the calling user has subscribed to the caller information service, sending the request for caller information to the caller information server; otherwise, not sending the request for caller information to the caller information server.

24. The method of claim 1, further comprising:
configuring a service flag indicating whether a calling user has subscribed to a caller information service and a segment of calling number for subscribing to the caller information service;
before sending the call request to the called terminal, determining, by the switching system, whether the calling number is in the segment of calling number, if the calling number is in the segment, setting the service flag as valid, sending the service flag along with the call request to the called terminal;
determining, by the called terminal, according to the service flag, whether the calling user has subscribed to the caller information service, if the calling user has subscribed to the caller information service, sending the request for caller information to the caller information server; otherwise, not sending the request for caller information to the caller information server.

25. The method of claim 1, further comprising:
configuring a service flag indicating whether a calling user has subscribed to a caller information service and a prefix number for subscribing to the caller information service;
determining, by the switching system, before sending a call request to the called terminal, whether the calling number comprises the prefix number, if the calling number comprises the prefix number, setting the service flag as valid, sending the service flag along with the call request to the called terminal;
determining, by the called terminal, according to the service flag, whether the calling user has subscribed to the caller information service, if the calling user has subscribed to the caller information service, sending the request for caller information to the caller information server; otherwise, not sending the request for caller information to the caller information server.

26. The method of claim 1, wherein the caller information server comprises one of: Service Control Point (SCP), USSD server, and Personal Information Management (PIM) server.

27. A system for outputting caller information, comprising:
a switching system for sending a call request carrying a calling number;
a called terminal for sending, upon receiving the call request carrying the calling number from the switching system, a request for caller information carrying the calling number according to the calling number, and displaying the caller information;
a caller information server for saving the caller information, and querying the caller information according to the calling number carried in the request for caller information received from the called terminal, and returning the caller information corresponding to the calling number to the called terminal.

28. A terminal comprising means for sending a request for caller information to a caller information server upon receiving a call request, and outputting the caller information upon receiving the caller information from the caller information server.
